(19) United States
(12) Patent Application Publication
(10) Pub. No.: US 2015/0337593 A1
(43) Pub. Date: Nov. 26, 2015

(54) Prismatic Window Shade To Provide Daylight Directing Control

(71) Applicant: 10X TECHNOLOGY LLC, Libertyville, IL (US)

(72) Inventor: Robert M. PRICONE, Libertyville, IL (US)

(21) Appl. No.: 14/652,918

(22) PCT Filed: Dec. 17, 2013
(86) PCT No.: PCT/US2013/075842

§ 371 Date: Jun. 17, 2015

Related U.S. Application Data
(60) Provisional application No. 61/738,218, filed on Dec. 17, 2012.

(51) Int. Cl. E06B 9/42

(52) U.S. Cl. CPC E06B 9/42

(57) ABSTRACT

A roller type window shade for directing daylight onto the ceiling of an associated room in which the shade is positioned on a window of such room, the shade comprising a polymer film having a width commensurate with the width of the associated window and length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

### RELATED APPLICATIONS

This application claims priority to U.S. Provisional Patent Application No. 61/738218, filed on Dec. 17, 2012, which is incorporated herein by reference in its entirety.

### STATEMENT OF THE INVENTION

Prismatic structures have been used in the past to direct sunlight into offices, retail stores, public buildings and homes to provide natural lighting and reduce the need for artificial lighting. Luxfer, circa 1910, was an example of this using glass prism structures in windows to direct light into work areas that benefited from natural lighting. Though the Luxfer product was an effective attempt to direct sunlight into buildings it is was expensive, heavy and limited in efficiency to the area of prisms installed in the structure. More recently Serra Solar has been test marketing a similar concept using a micro-prism polymeric product that is less expensive and can be attached to windows but once installed occupies a fixed area of the window. (See U.S. patents assigned to Serra Solar U.S. Pat. No. 5,731,900 (Milner) and U.S. Pat. No. 5,880,886 (Milner); also see Chi Lin U.S. Pat. No. 8,107,164 (Tsai)

The need for natural lighting still exists but improvements to the original Luxfer concept have not met the needs of the building and architectural community. To address the need to bring daylight into work areas a microreplicated polymeric version of aspects of the Luxfer concept has been produced by SerraSolar Inc. of San Jose, Calif. Various prism geometries can be produced to redirect light at different angles but since the geometry is miniaturized by microreplication the product can be manufactured as a thin film, typically 350 to 400 μm thick and at much lower cost. This product has already been reduced to practice.

Because the prism film is not image transparent, an entire window cannot be covered if there is a need to see through the window. In order to solve this problem with prism films, and to simply and effectively change the area of the window that can redirect daylight, the invention herein comprises a prism film that can be incorporated in a roller type shade that can increase or decrease both the daylight directing and image visible area of the window. The novel shade can be operated manually or by remote control to vary the daylight directing area at will depending on the need for light or time of day, or the amount of through window visibility desired.

In one embodiment of the invention, a roller window shade comprises a film having at least one microprismatic area integrally formed on said film, said film to provide daylighting direction control for redirecting incoming daylight to the ceiling of an associated room in which the shade is located on a window in a wall of the associated room, and whereby the vertical position of the shade can increase or decrease both the daylight directing and image visible area of the associated window.

In one aspect of the invention, the roller window shade further includes at least two microprismatic areas on the shade, each microprismatic area having a different prismatic angular configuration for directing incoming sunlight to different locations of the ceiling.

In another aspect of the invention, the roller window shade comprises a polymer having a width and length, and wherein said microprismatic area extends over the full width thereof and over a portion of the length thereof.

In another aspect of the invention, the roller window shade comprises different microprismatic areas that are spaced longitudinally from one another along the width of said shade.

In another aspect of the invention, the roller window shade comprises a polymer film and wherein the microprismatic area is integrally formed as a part of said film.

In another aspect of the invention, the roller window shade comprises a polymer film and wherein the microprismatic area is integrally formed as a part of said film, in which the polymer optionally comprises one or both of a UV absorber and an IR reflecting or absorbing layer, thereby to allow said shade to diminish damage caused by UV radiation and to effectively diminish IR heat from the associated room while still directing daylight entering the room.

In another aspect of the invention, the roller window shade comprises a polymer that is PMMA, the microprisms have a height of about 0.250 mm and a pitch of 0.207 mm, said film having a total thickness of about 0.375 mm.

In one embodiment of the invention, a roller type window shade for directing daylight onto the ceiling of an associated room in which the shade is positioned on a window of such room comprises a polymer film having a width commensurate with the width of the associated window and a length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

In another aspect of the invention, the roller type window shade further includes at least first and second microprismatic areas on the shade, each microprismatic area having a different prismatic angular configuration for directing incoming sunlight to different locations of the ceiling.

A typical daylight prism has 45 degree angles with a height of 0.250 mm and a pitch of 0.207 mm. The overall thickness of the film is typically 0.375 mm thick and can be fabricated from PMMA, Polycarbonate, Polyurethane or various other polymers. To assure damaging UV radiation is controlled, UV absorbers can be added to the polymer substrates so only the visible wavelengths are transmitted. A further advantage of this concept includes adding IR reflecting or absorbing layers allowing the same product to effectively diminish IR heat from the room while still directing daylight.

Yet another advantage of this product is the ability to provide an embodiment having two different prismatic areas in the same shade for some regions of the shade. One prismatic area in the summer months would have prisms optimized with the solar elevation angle for that time of the year and have IR reflecting or absorbing layers to diminish IR heat from the room. A second prismatic area in the same shade would be optimized for the solar elevation angle in winter months and without the IR reflecting or absorbing layers to provide more radiant heat in the winter.

### EXPLANATION OF THE ILLUSTRATIONS

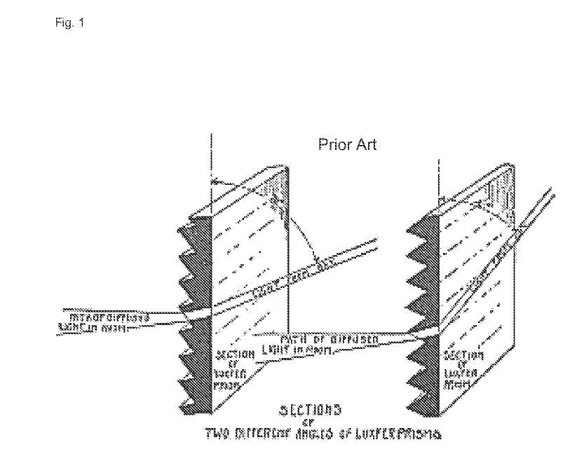

FIG. 1 is a catalog illustration circa 1910 of glass prism arrays manufactured by Luxfer that purported to direct sunlight into work areas.

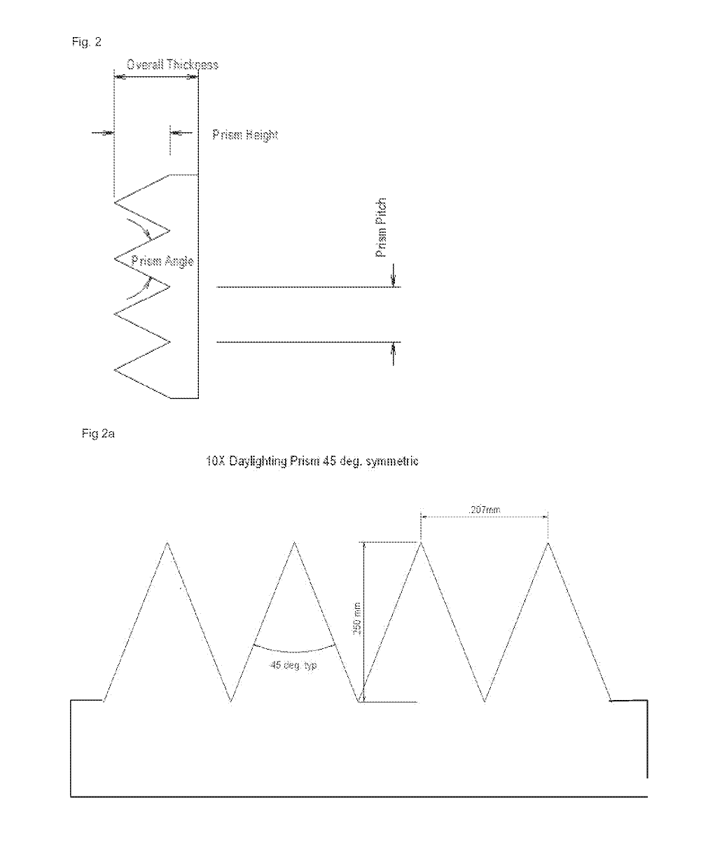

FIG. 2 illustrates prism angle, prism height, pitch and overall thickness of the film as those terms are used in this application.

FIG. 2a is an example of a microstructured product of the present invention that can be manufactured using a variety of polymers suitable for light transmission, flexibility and weatherability. Impact modified PMMA, polycarbonate and polyurethane are among the preferred materials.

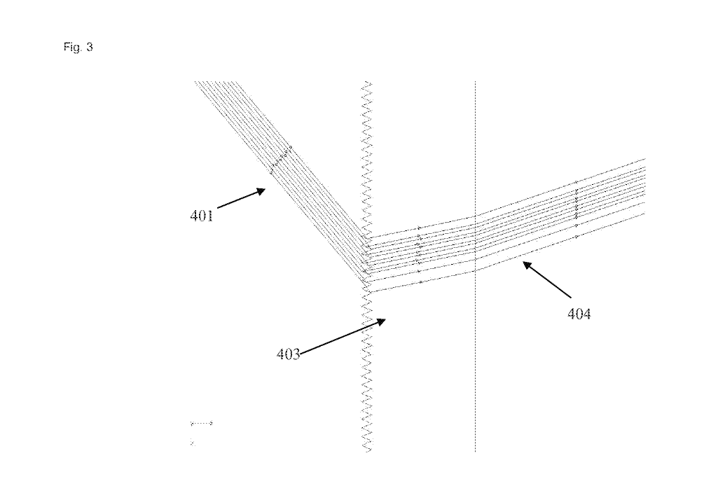

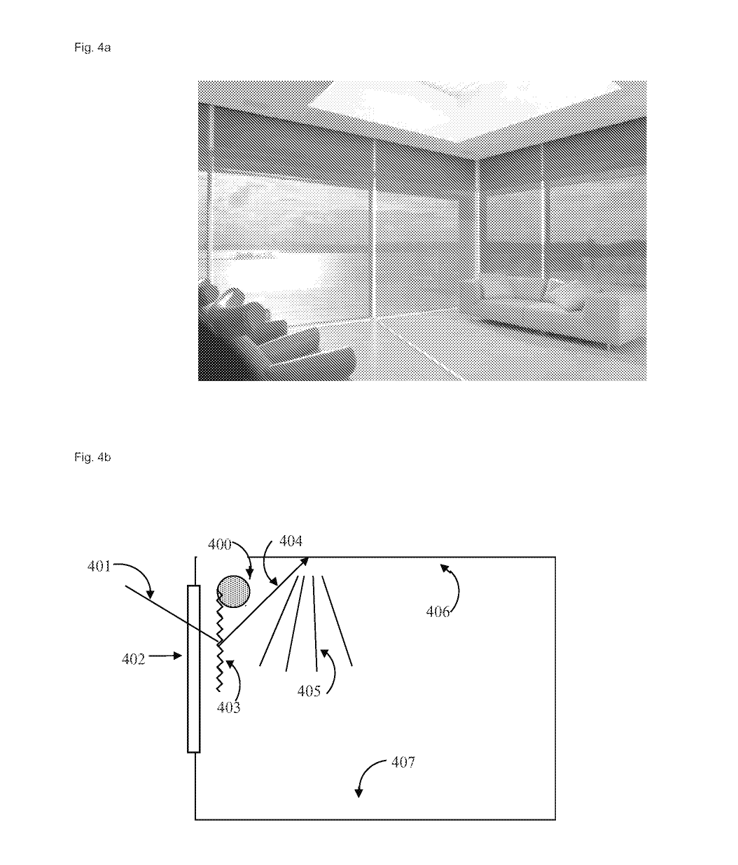

FIG. 3 represents a typical incident light ray path 401 for sunlight at a 50 degree elevation from the left passing through a microprism film product 403. As shown the sunlight ray 401 is being refracted 404 and redirected by the microprismatic film 403 into an adjacent room at a 20 degree angle. Variations in prism angle can provide different exit angles to allow light to be directed towards the ceiling or directly into the work area.

FIG. 4a is an example of a room having microprismatic film shade provided as retractable allowing more or less daylight into the room as desired.

FIG. 4b is a functional example of the invention incorporating microprismatic film into a shade 400 that is variably adjustable in height allowing more or less daylight into the work area of the room 407 as desired. Sunlight rays such as 401 pass through a window 402 and are redirected as at 404 by the microprismatic film 403 in the shade 400 to the ceiling 406. The ceiling 406 diffuses the light 405 into the room 407. The roller shade 400 can be adjusted to any height to allow maximum redirection of the light towards the ceiling, partial distribution or none if maximum visibility through the window is required. The prism angle such as in FIG. 2 (or combination of prism angles) will direct light at different exit angles as required by the architect. IR reflecting or IR absorbing material can be incorporated in the polymer to reject heat while enhancing the level of daylight in the room. UV absorbing material can also be incorporated to reduce damage to furniture, carpeting and art while also enhancing the level of daylight in the room. The roller shade mechanism may be of well known standard manual, spring operated, or electrically controlled design, and forms no part of the invention.

FIG. 5 illustrates how different variable prisms geometries may be placed at different heights on the film forming the window shade so that the ceiling is illuminated throughout the entire depth of the room. The ceiling is reflective white, and possibly contoured to scatter light below. Although the solar angle varies over day and season, static daylighting prism designs can be designed around the best average geometry. Zones with different prisms formed at different windows heights direct light toward different areas of the ceiling.

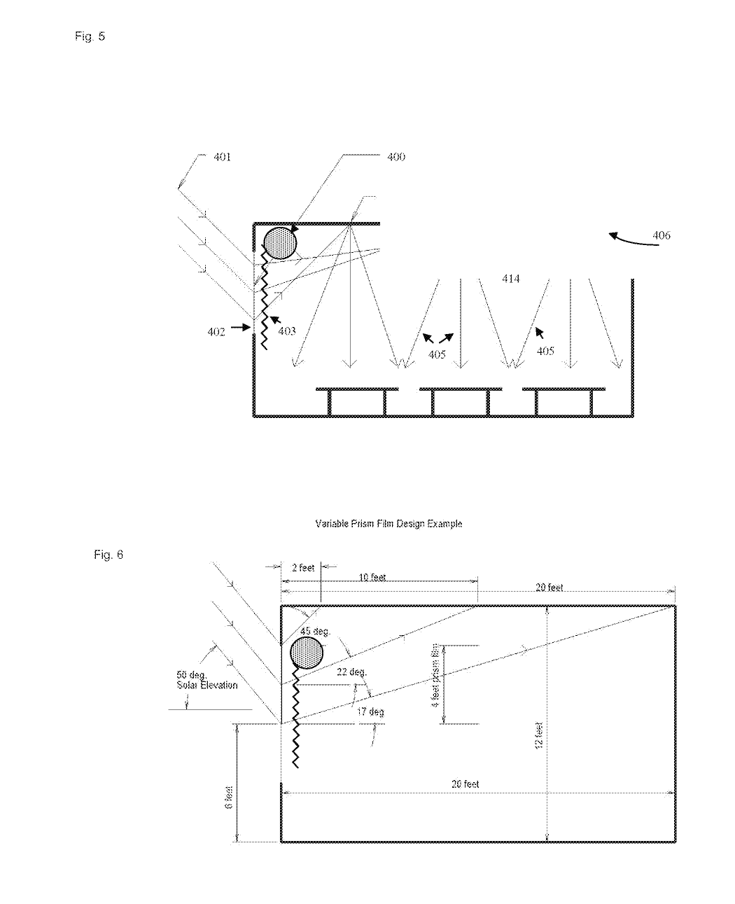

A specific design example for variable prism film that could broadly apply is generally illustrated at FIG. 6 and can be described as follows:

For most populated areas of the Northern hemisphere, the latitude is about 40 degrees. So at noon on the equinox, the solar elevation angle is at 50 degrees; this is the best estimate of “average” sun angle.

Many examples of south facing windows are in existence, and many newer window openings are taller, perhaps 6-10 feet above the floor and do not have important visual see thru function. An average office or work room depth is perhaps 20 feet.

FIG. 6 As an example of effective zones to distribute solar illumination, a plurality of upwardly redirected solar ray angles might be as shown. At the six foot elevation, just above eye-height, transmitted rays are at ˜17 degrees upward to be directed at the far back corner of the room. If the light at mid window height is to be redirected toward the middle of the ceiling, the refracted angle is ˜22 degrees. A practical angle for light redirection near the top of the window is ˜45 degrees.

So if the correct variable prisms are applied to a shade that covers the upper zones of a window as illustrated, sunlight will be redirected onto the inner 18 feet of the ceiling and thus illuminate the depth of the room.

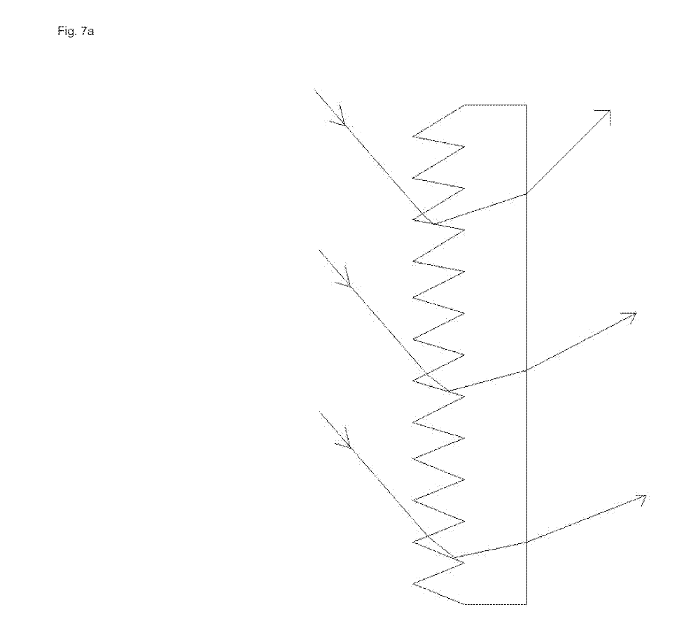

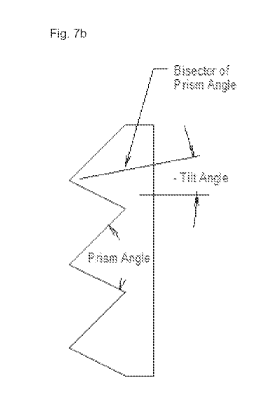

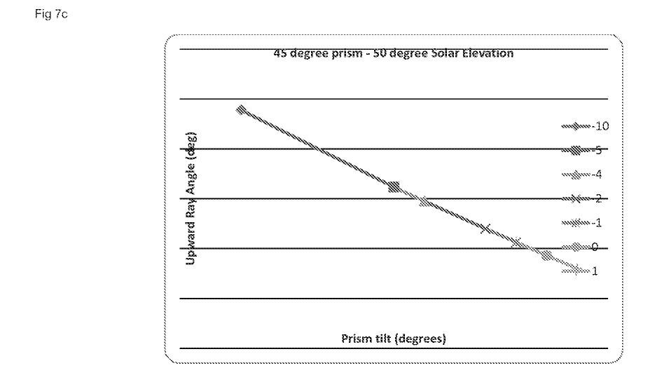

The 45-0 prism design as shown in FIG. 2 (a symmetric 45 degree prism angle, zero degree tilt angle) described above can be easily modified for this range of angles, where tilt angle is defined as illustrated in FIG. 7b. For a 45 degree prism tilted at 10 degrees (45+10 design), light incident at 50 degrees solar elevation will be directed upward at 48 degrees. Typical dimensions for this prism would be 0.250 high, with a 0.207 mm pitch.

Total thickness of the substrate is typically 0.375 mm.

Polymeric microprismatic film as described herein can be manufactured by hot polymer embossing as described in Pricone U.S. Pat. No. 4,486,363. Using this process different zones of microprisms can be incorporated in the embossing belt allowing the polymeric microprismatic product to be manufactured continuously with zones repeating as necessary corresponding to the lengths necessary for use in the shade.

FIG. 7a For various tilt angles of the 45 degree prism light incident at the 50 degree solar elevation angle is directed upward as shown in FIG. 7a.

FIG. 7b defines prism tilt angle as the tilt of the prism bisector with respect to the film FIG. 7c For the design example in FIG. 7a, the prism geometry should vary from About 45+1 at the lower edge to ˜45-2 at center and 45-9 at the upper edge. A range of prisms that include similar function as the series of Luxfer prism tiles are easily formed into micro-prism film strips or a continuously variable prism film.

What is claimed is:

1. A roller window shade comprising a film having at least one microprismatic area integrally formed on said film, said film to provide daylighting direction control for redirecting incoming daylight to the ceiling of an associated room in which the shade is located on a window in a wall of the associated room, and whereby the vertical position of the shade can increase or decrease both the daylight directing and image visible area of the associated window.

2. The shade of claim 1, and further including at least two microprismatic areas on the shade, each microprismatic area having a different prismatic angular configuration for directing incoming sunlight to different locations of the ceiling.

3. The shade of claim 1 or 2, and wherein the shade comprises a polymer having a width and length, and wherein said microprismatic area extends over the full width thereof and over a portion of the length thereof.

4. The shade of claim 3 wherein the different microprismatic areas are spaced longitudinally from one another along the width of said shade.

5. The shade of claim 1, in which the shade comprises a polymer film and wherein the microprismatic area is integrally formed as a part of said film.

6. The shade of claim 5, in which the polymer optionally comprises one or both of
a UV absorber and an IR reflecting or absorbing layer, thereby to allow said shade to diminish damage caused by UV radiation and to effectively diminish
IR heat from the associated room while still directing daylight entering the room.

7. The shade of claim 5, and wherein the polymer is PMMA, the microprisms have a height of about 0.250 mm and a pitch of 0.207 mm, said film having a total thickness of about 0.375 mm.

8. A roller type window shade for directing daylight onto the ceiling of an associated room in which the shade is positioned on a window of such room, the shade comprising a polymer film having a width commensurate with the width of the associated window and a length commensurate with the length of the associated window, said film having at least one microprismatic area integrally formed as part of said film and extending along the width of said shade for redirecting daylight upwardly toward the ceiling of the associated room, and whereby the position of the shade can increase or decrease both the daylight directing and image visible area of the associated window.

9. The shade of claim 8, and further including at least first and second microprismatic areas on the shade, each microprismatic area having a different prismatic angular configuration for directing incoming sunlight to different locations of the ceiling.
